(19) United States
(12) Patent Application Publication
(10) Pub. No.: US 2021/0191745 A1
(43) Pub. Date: Jun. 24, 2021

(54) SYSTEM AND METHODS FOR RECONSTITUTING AN OBJECT IN A RUNTIME ENVIRONMENT USING HEAP MEMORY

(71) Applicant: CERNER INNOVATION, INC., Kansas City, KS (US)

(72) Inventor: Isaac Pacht, Flushing, NY (US)

(21) Appl. No.: 16/720,969

(22) Filed: Dec. 19, 2019

(51) Int. Cl. G06F 9/455; G06F 9/38; G06F 11/07

(52) U.S. Cl. CPC G06F 9/45558; G06F 9/45504; G06F 2009/45583; G06F 11/0778; G06F 9/3879

(57) ABSTRACT

Methods, systems, and computer-readable media are disclosed herein to provide for reconstituting an object from raw data in a heap dump. Embodiments herein provide for retrieving raw data from a managed heap dump, where the raw data corresponds to an object. The raw data is retrieved from the heap dump and loaded into a running computer application within a runtime environment, in embodiments. The raw data is transformed, in some embodiments, by regenerating the actual object from the content of the object that is represented in the raw data, through the running computer application. Various utilities may then be used on the regenerated object to reveal the internal structure of the object for program logic diagnosis, in embodiments.

### BACKGROUND

During software production, errors may be produced based on the state of one or more objects. However, unless the state of an object has been explicitly serialized to a durable storage medium, it is not accessible after the production fails, such that troubleshooting cannot be performed on the object directly. Instead, a heap dump, if available, may be searched to locate raw data that corresponds to the object. However, in order to locate the raw data, the name or address of the object is generally known and provided by a developer. Further, in order to diagnose the production failure, the developer generally needs to have detailed knowledge of the internal structure of the object and/or the class of the object in order to understand the raw data. Often times, even with such knowledge of the internal structure of an object, the internal structure of an object is too complex for the raw data to be understood or interpreted for any insight regarding the error.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The present invention is defined by the claims as supported by the Specification, including the Detailed Description.

In brief and at a high level, this disclosure describes, among other things, methods, systems, and computer-readable media for generating an object using raw data retrieved from a heap dump.

In one embodiment, a computerized method is provided. The method comprises receiving raw data representing an object at a virtual machine, the raw data received from a heap dump, in embodiments. The method continues by transforming the raw data into an object in the virtual machine. Then, the method executes a call or a method on the object, in an embodiment.

In another embodiment, one or more non-transitory computer-readable storage media are provided for storing computer instructions thereon for execution by one or more processors to perform a method. The method comprises receiving an indication of an object identifier, in embodiments. Raw data that represents an object corresponding to the object identifier is identified in a heap dump, in embodiments. The raw data may be loaded into a virtual machine and, in embodiments, the raw data is transformed into the object within the virtual machine.

In one embodiment, a computerized system is provided in an embodiment of the present invention. The system comprises one or more processors configured to receive input that identifies an object. The system may then locate, via the one or more processors, raw data in the heap dump that represents the object identified in the input in some embodiments. The raw data that represents the object may then be retrieved from the heap dump, in an embodiment. In some embodiments, the raw data that represents the object is loaded into a virtual machine and the raw data is transformed into the object within the virtual machine. Then, a call or a method may be performed with regard to the object that was generated from the raw data.

### BRIEF DESCRIPTION OF DRAWINGS

Illustrative embodiments of the present invention are described in detail below with reference to the attached drawing figures, and wherein:

FIG. 1 depicts a block diagram of an example computing environment in accordance with an embodiment of the present invention;

FIG. 2 depicts an example method for reconstituting objects from raw data in a heap dump in accordance with an embodiment;

FIG. 3 depicts another example method for reconstituting objects from raw data in a heap dump in accordance with an embodiment;

FIG. 4 depicts yet another example method for reconstituting objects from raw data in a heap dump in accordance with an embodiment; and

FIG. 5 depicts a block diagram of an example system suitable to implement embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include other steps or combinations of steps similar to the ones described in this document, in conjunction with other present or future technologies. Moreover, although the terms “step” and/or “block” may be used herein to connote distinct elements of methods employed, the terms should not be interpreted as implying any particular order among or between various steps herein disclosed unless and except when the order of individual steps is explicitly described. Further, it will be apparent from this Detailed Description that the technological solutions disclosed herein are only a portion of those provided by the present invention. As such, the technological problems, solutions, advances, and improvements expressly referenced and explained should not be construed in a way that would limit the benefits and application of embodiments of the present invention.

Embodiments herein provide for regenerating objects from raw data that is stored in a heap dump. As used herein, a “heap dump” refers to data that encodes information about a memory of a process. The data may encode information in the heap dump that describes objects, classes, and/or roots as assessed for a runtime process at a specific point in time, in embodiments. In this manner, the heap dump provides a static “snapshot” of memory for a process, for example, a Java process as determined at a specific point in time. The heap dump is written at a specific point in time, and thus, the heap dump thereof provides static information about objects and classes for a particular and finite point in time during a process being executed in a runtime environment, in an embodiment. Once written, the heap dump acts as a persistent memory of the process at the specific point in time, in embodiments. The heap dump may be written to a work directory, for example. The heap dump may encode the information for all objects, all classes, and/or all garbage collection roots, for example, for a specific or particular point in time for a runtime process, in some embodiments. The heap dump data may encode information that describes, for a point in time of a process, a class, a field, a primitive value, a reference, a class loader, a name, a super class, a static field, objects, objects defined by a virtual machine (e.g., a Java virtual machine (JVM)), call-stacks, thread stacks, local variables, or any combination thereof, in various embodiments. In embodiments, the heap dump encodes information as raw data that is at least partially formatted or partially structured, such that the heap dump is “managed.” Examples of a heap dump include HPROF binary heap dumps, IBM™ System dumps, and IBM™ portable heap dumps (PHD).

In one embodiment, the heap dump is an IBM™ Software Developers Kit (SDK) for Java Portable Heap Dumps, and the heap dump contains information for objects, classes, and links between objects. Heap dumps are important and provide developers with the ability to diagnose and troubleshoot memory issues or errors in program logic. The embodiments herein may be used to identify and debug program logic, which may result in a program producing incorrect or inaccurate results, and/or may result in the program “crashing.” Through embodiments herein, program logic that produces errors may be identified and debugged. This may be beneficial in scenarios where, for example, a debugging utility may not be attached to a virtual machine. It will be understood that errors in programming logic are at technological problem that arises from and is specific to the computer technology itself.

It will be understood from this Detailed Description, that the embodiments herein are not limited to one specific type or category of heap dump, and other system dumps, Java dumps, and heap dumps are contemplated to be within the scope of the invention such that the examples herein are not be construed as limiting. Moreover, although IBM™ systems may be referred to herein, it will be understood from this Detailed Description that the embodiments herein are not limited to one specific platform or operating system, and other platforms and operating systems are contemplated to be within the scope of the invention such that the examples herein are not be construed as limiting. The embodiments herein are discussed with regard to Java for clarity and simplicity only, and other computer programming languages, other runtimes, other systems, and other platforms that employ objects and/or heap-type memory are contemplated to be within the scope of the invention and the examples herein are not to be construed as limiting.

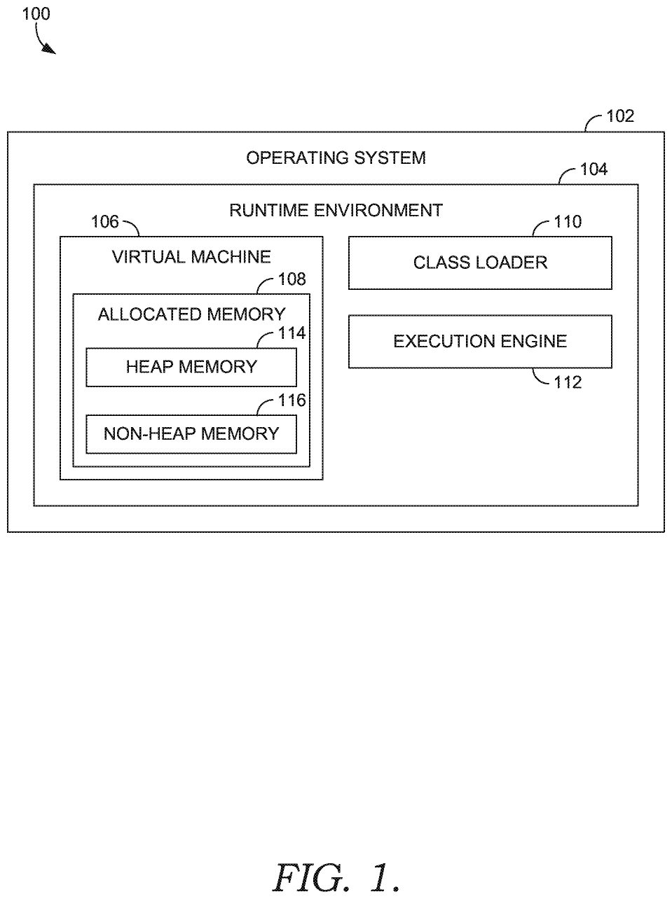

Referring to the drawings in general, and initially to FIG. 1, a block diagram illustrating an example of a computing environment 100 in which embodiments of the present disclosure may be employed is provided. It should be understood that the placement of various components is an abstraction such that one or more of the various components may be located or may operate anywhere within the operating system 102, runtime environment 104, and/or virtual machine 106. For example, the class loader 110 and execution engine 112 may be located or may operate within the virtual machine 106, although the components are not depicted as nested within the virtual machine 106 in FIG. 1. Therefore, the depicted arrangement is only an example. Accordingly, other components and arrangements may be used additionally or instead of that which is depicted, such that other components not shown may also be included within the environment, and one or more of the shown component may be omitted, in various embodiments. It should be understood that any number of components shown in FIG. 1 may be employed within the computing environment 100 within the scope of the present invention. Each component may be implemented via a single device or multiple devices cooperating in a distributed environment. Accordingly, the computing environment 100 may include one or more of a variety of computing devices (not shown), any of which can interact with any other component of the computing environment 100 and each of which are communicatively coupled with each other. Further, the components shown may be implemented as discrete components, distributed components, or in conjunction with other components, and in any suitable combination and physical or virtual location. The functions described herein as being performed by one or more components, entities, and/or devices may be carried out by hardware, firmware, and/or software, in embodiments, such that the functions are not limited unless explicitly described as such.

It should also be understood that the computing environment 100 shown in FIG. 1 is only one example of a suitable computing environment 100, and this example has been simplified for ease of discussion. Each of the components of FIG. 1 may be implemented using any type or number of computing devices, in embodiments. The components may communicate with each other directly or, for example, indirectly via a network, including one or more of a telecommunication network, a local area network (LANs), a wide area network (WANs), and/or a peer-to-peer-network. Such networking environments may include campus-wide or enterprise-wide computer networks, intranets, and the Internet.

The operating system 102 may be embodied on one or more computing devices, in one embodiments. In embodiments, the computing environment 100 may include hardware and software of a computing device that supports an operating system 102, in embodiments. Computing devices may be embodied as a physical server; a virtual server; a plurality of physical and/or virtual servers; a personal computer such as a laptop or desktop computing device; a distributed system comprised of a plurality of personal computers; a mobile device such as a smartphone, a tablet computer, and/or wearable device, such as a smartwatch or a fitness tracker; a global positioning system (GPS) device; an embedded system controller; a consumer electronic device; or any combination of thereof. In embodiments, the computing environment 100 may employ one or more processors of a computing device that support an operating system 102. Within the operating system 102, there may be a runtime environment 104. In embodiments, the runtime environment 104 includes one or more of a virtual machine 106, allocated memory 108, class loader 110, and execution engine 112. In some embodiments, the runtime environment 104 is a virtual container. The runtime environment 104 may be a container for a computer program that loads one or more computer applications into the virtual machine 106, in some embodiments. The runtime environment 104 may be a Java runtime environment, in one embodiment.

The virtual machine 106 in the runtime environment 104 may execute one or more computer applications that are loaded into the virtual machine 106 from the runtime environment 104, in embodiments. In one embodiment, the virtual machine 106 may specifically be a Java virtual machine. The class loader 110 may operate to load computer programming code for computer applications, utilities, methods, and the like, into the virtual machine 106 and may connect the computer programming code to one or more class libraries (not shown). The class loader 110 may load one or more classes from one or more class libraries into the virtual machine 106, in embodiments. The execution engine 112 may execute the computer programming code that was loaded into the virtual machine 106 from the class loader 110, in embodiments. The execution engine 112 may have a compiler, in some embodiments, such as a just-in-time compiler (not shown). The execution engine 112 may execute the compiled computer programming code, in view of the one or more classes connected to the computer programming code by the class loader 110, in order to run computer applications, utilities, methods, and the like.

In embodiments, the virtual machine 106 includes allocated memory 108. The allocated memory 108 may refer to a memory area or a memory space that is allocated or provided to the virtual machine 106 by the operating system 102. The allocated memory 108 may store a heap memory 114 and a non-heap memory 116, in some embodiments. In various embodiments, the non-heap memory 116 may correspond to native, off-heap, direct, or any other non-heap memory area. Native memory may be a memory area or memory space that is allocated for storing data that acts as virtual memory for internal data, for example. Within the allocated memory 108, the heap memory 114 may be a memory area or memory space that is allocated for storing data for one or more objects. In some embodiments, the heap memory 114 may include a heap dump that stores raw data, as further described hereinafter. A heap dump may be generated and raided in order to diagnosis memory-related problems, for example, when an object may not be accessible. In one example, a heap dump may be generated using “jmap” (i.e., part of the Java Developer Kit) to print a heap dump to a specified file location, such as a \bin folder. It will be understood that is only one example and multiple other options may be used to generate a heap dump, and as such, this example should not be construed as limiting.

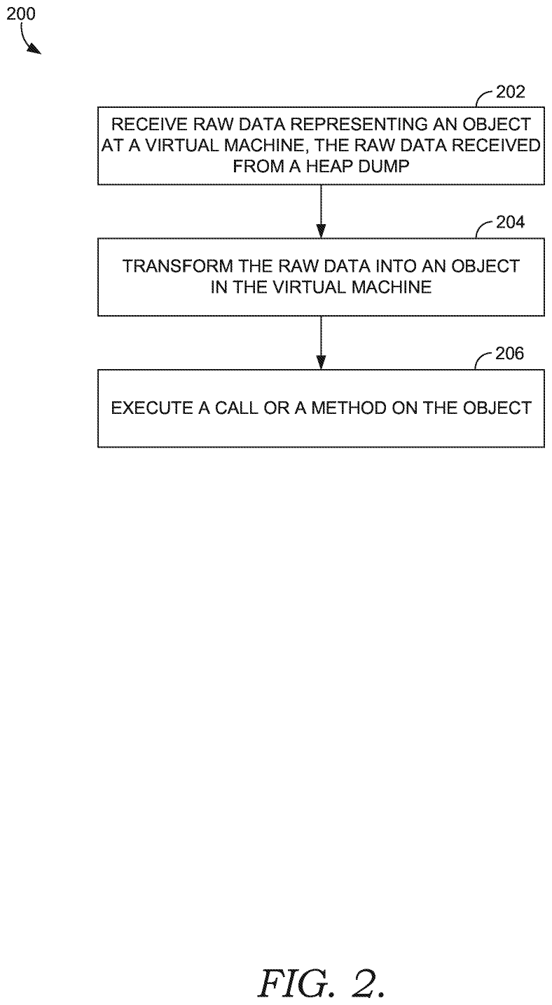

Having described the computing environment 100 and components in FIG. 1, interactions one or more of the components are now described with reference to the flow charts of FIGS. 2-4. FIGS. 2-4 provide methods for reconstituting objects from raw data in a heap dump. In some embodiments, the methods may be computer-implemented methods. In one embodiment, one or more non-transitory computer-readable storage media having computer-readable instructions or computer-readable program code portions embodied thereon, for execution via one or more processors, can be used to implement and/or perform the methods. For example, computer-readable instructions or computer-readable program code portions can specify the performance of the methods, can specify a sequence of steps of the methods, and/or can identify particular component(s) of a software and/or hardware for performing one or more of the steps of the methods, in embodiments. As discussed below, the methods may be performed using software, hardware, component(s), and/or device(s) depicted in the example of FIGS. 2-4. For example, one or more steps of the methods can be performed at a computing device, using one or more processors of the computing device, to support a runtime environment.

FIG. 2 depicts a flow chart for a computerized method 200. At block 202, raw data representing an object may be received at a virtual machine. In an embodiment, the raw data represents content of the object. In embodiments, the raw data may be received from a heap dump, such as a heap dump within heap memory 114 of the allocated memory 108 of FIG. 1, for example. For example, a Java-formatted heap dump may store partially formatted or partially structured raw data that represented one or more objects, wherein a class of an object and fields of an object may be discernable based at least on the partial structuring of the raw data. In various embodiments, the heap dump is a managed heap dump based on the at least partially structured or partially formatted aspects of the raw data. Examples of managed heap dumps may be found in environments using C#, Python™, .Net, and other runtime environments.

In some embodiments, raw data is received in response to a query of the heap dump. For example, a query may be received that specifies a particular object identifier that is desire to be retrieved from the heap dump, and the query may be used to search the raw data in the heap dump for raw data the specifies or include the particular object identifier in the query. The object identifier may include an object name or a memory address, for example. In response to the query, the raw data that represents a particular object corresponding to the particular object identifier may be extracted from the heap dump, in an embodiment. The extracted raw data may be passed to the virtual machine, in some embodiments.

In an embodiment, a utility API is used to parse the heap dump and pass the raw data to the virtual machine. A parsing utility is used to call and search the heap dump, in an embodiment. The parsing utility may be provided with a specific object address, for example, when a specific object address has been determined externally, or the parsing utility may be provided with query parameters from which an object or objects to be extracted may be determined based on class, field values, or any other identifying characteristics of an individual object, or group of objects, in some embodiments. The raw data located by using the parsing utility may be provided to the virtual machine, in embodiments.

At block 204, the raw data may be transformed into an object in the virtual machine. In some embodiments, the virtual machine is a Java virtual machine. In embodiments, the object in the virtual machine is an instance of a class. In such embodiments, the object exhibits a behavior of the class in the virtual machine. It will be understood that an object generally exhibits behavior of a class, whereas the raw data the corresponds to an object does not exhibit behavior. In some embodiments, transforming the raw data into the object includes generating, from the raw data that includes or encodes the content of the object, a string representation of the content of the object. The raw data may be transformed once input into the virtual machine 106 of FIG. 1, in some embodiments, and using the execution engine 112 to execute computer programming code as connected to one or more classes by the class loader 110, in order to reconstitute the object from the content within the raw data. In some embodiments, a reflection application programming interface or utility is employed by the virtual machine to build the object within the running virtual machine.

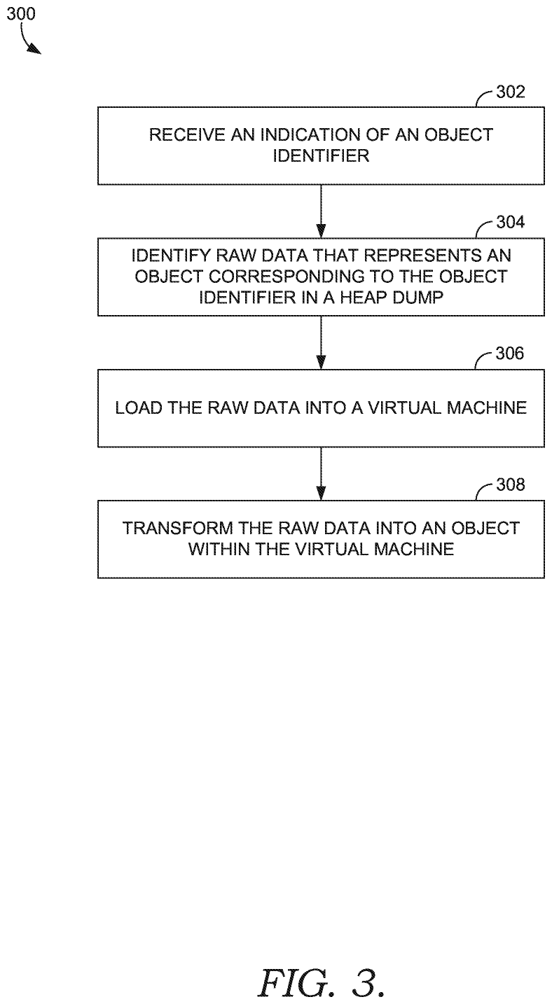

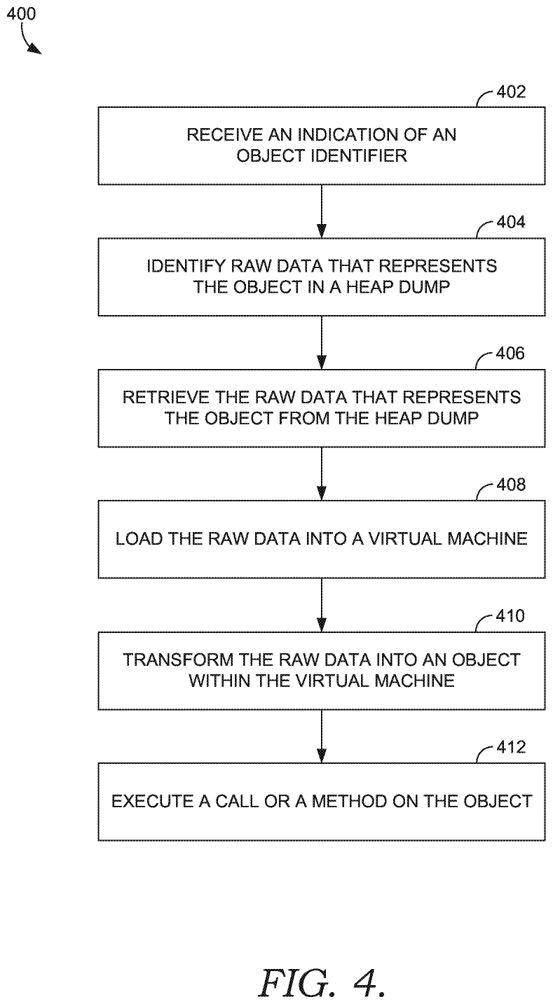

At block 206, a call or a method is executed with regard to the object. In embodiments, executing a call or a method on the object that was generated may include printing the object to string. Accordingly, using the method 200, raw data is loaded into a running computer application in the virtual machine in order to regenerate or “reconstitute” the actual object itself using only the content encoded in the raw data. Once regenerated from the raw data, the object may be manipulated, for example, by calling a method to print the object to string. Printing the object to string produces a string that identifies the internal structure the object and values of the object, wherein the internal structure and values may not have been visible or interpretable when represented as the raw data. In some embodiments, the string specifies a value for the object (e.g., value for one or more fields). Based on the string, program logic errors may be identified and diagnosed. It will be understood that a call to string is only one example for generating output for an object, and thus, other methods for revealing object information, including the internal structure, such as field(s) and value(s) are contemplated and are within the scope of the invention such that this example should not be construed as limiting this method or the other methods discussed herein. It should be understood that embodiments of all of the methods herein may use any utility, call, or method available within the runtime environment 104 to perform tasks or obtain information regarding the raw data and/or object. It should be understood that any and all steps or “blocks” and the detailed discussed therein with regard to the methods of FIG. 2 may be used or employed in the methods of FIGS. 3 and 4.

Continuing, FIG. 3 depicts a flow chart for a computerized method 300 for regenerating or “reconstituting” an object from raw data in a heap dump. At block 302, an indication of an object identifier may be received. The indication of the object identifier may specify an object name or a memory address for the object, for example, as input by a developer. In embodiments, the object identifier may include an object name, an object (memory) address, a class for the object(s), and/or a field identifier, for example. the object identifier may be used to query the heap dump, as previously described, in order to identify and locate raw data in the allocated memory that represents content of the object corresponding to the object identifier.

In some embodiments, an object identifier may not include or may not specify an object name. For example, the specific name for a particular object may not be available or may not be known to a developer; however, the developer may have knowledge of a class, a field in an object or a field for objects of a particular class, a construct for a class or field, and/or a value for a field. An input or indication of non-name information may be used to search, identify, locate, and/or extract raw data from the heap dump, in some embodiments. Therefore, raw data may be obtained from a heap dump for objects even when an object may not be individually identifiable by name and/or internal structure, for example. In one embodiment, a reflection application programming interface that calls at least one of a particular object class, a particular field, and/or a particular value may be executed to locate raw data, as previously described herein. Thus, using a reflection application programming interface, for example, an object name is not required to be specified in order to obtain raw data that includes content of an object from the heap hump. It will be understood that a reflection application programming interface is only one example for retrieving raw data for object(s) in the absence of an object name, and thus, other methods for retrieving the raw data are contemplated and are within the scope of the invention such that this example should not be construed as limiting.

At block 304, raw data in the heap hump is identified that represents an object corresponding to the object identifier that was received. For example, using the object identifier received (e.g., one or more of an object name, a memory address for a specific object, a class for an object, a field in an object, a field for a particular class, a construct for a class or field, or a value for a specific field), raw data that represents an object corresponding to the object identifier may be identified within the heap dump. The raw data that corresponds to the object may be data that represents or includes the content of the object itself, though the raw data is not the object and does not exhibit behavior as an object, in embodiments.

At block 306, the raw data may be loaded into a virtual machine. In some embodiments, the virtual machine is a Java virtual machine. In an embodiment, the raw data is loaded into the virtual machine, for example, by inputting the raw data into a running computer application. A running computer application refers to the execution of computer programming code for a program, utility, or method, in embodiments. A computer application may be executed within the runtime environment 104, or further, by the execution engine 112 within the runtime environment 104 of FIG. 1. Although the execution engine 112 is shown in FIG. 1 as separate from the virtual machine 106, it will be understood that the lines denoted in FIG. 1 are an abstraction such that the execution engine 112 may be integrated within the virtual machine 106. As such, when raw data may be “loaded” into a virtual machine, the method 300 may be transporting raw data from the allocated memory 108 area into the virtual machine, and further communicating the raw data as input to the execution engine 112 of FIG. 1, wherein the execution engine 112 has access to a computing programming language (code) that is usable for execution of a process using the raw data. Generally, in embodiments, the raw data is loaded into a virtual machine that is running the same software version as used by the process that generated the raw data. For example, when the raw data for an object was initially generated by a process executing a specific Java version, the raw data may be loaded into the virtual machine is executing the same specific Java version.

At block 308, the raw data may be transformed into an object within the virtual machine. Transforming the raw data into the object may include generating, from the raw data that represents or encodes the content of the object, a string representation of the content of the object, in some embodiments. In some embodiments, the raw data may be loaded into the virtual machine by placing the raw data into a running computer application. As such, the running computer application may transform the raw data into the object, wherein the running computer application may utilize class information to automatically identify an internal structure of the object for generation, in some embodiments. In further embodiments, when a call may be made on the object to print a string representation, for example, the string representation may be output that provides the internal structure of the object.

In embodiments, the object that is regenerated within the virtual machine is an instance of a class. The regenerated object may exhibit behavior of the class to which the object belongs, for example, within the virtual machine. In contrast, the raw data that was input or loaded into the virtual machine is static and generally does not exhibit class behavior, unlike the “live” regenerated object. In embodiments, the string representation may be used to diagnose the previously-discussed technological memory problems. By transforming the raw data into the object, and by generating a string representation of the object, a developer may be able to diagnosis the previously-discussed technological memory problems without having any prior knowledge or visibility of the internal structure of the object and corresponding class, for example. Additionally, it should be understood that any and all steps or “blocks” and the detailed discussed therein with regard to the methods of FIG. 3 may be used or employed in the methods of FIGS. 2 and 4.

Turning now to FIG. 4, it depicts a flow chart for a computerized method 400. The method 400 is discussed briefly herein with regard to those steps or aspects that are similar to the previously-discussed methods herein. Beginning at block 402, an indication of an object identifier may be received. The object identifier may be an object name, an object address, an object class, and/or a field name. In some embodiments, an input is received that identifies or specifies an object, directly by name or address, or indirectly by other identifiers, previously discussed herein. At block 404, in a heap dump, raw data may be identified that represents the object. In some embodiments, the raw data is stored in heap memory, or the heap memory specifies a file location to which the raw data was written as a heap dump. In one embodiment, the heap dump is searched and raw data is located that represents the object specified or identified in the indication or input that was received. As such, the raw data may be retrieved from the heap dump. In some embodiments, the heap dump is a Java-formatted heap dump that stores the raw data. In embodiments, the raw data represents content of the object, but the raw data is not an object itself, as previously discussed. At block 406, the raw data that represents or that corresponds to the object associated with the object identifier may be retrieved from the heap dump.

At block 408, the raw data that represents the object may be loaded into a virtual machine. As discussed above, in some embodiments, the virtual machine is a Java virtual machine. At block 410, the raw data may be transformed into the object within the virtual machine. For example, the object is regenerated or reconstituted from the raw data in a running computer application. Transforming the raw data into the object may include generating, from the raw data that represent the content of the object, a string representation of the content of the object, in some embodiments. The object generated in the virtual machine may be an instance of a class, and the object may exhibit a behavior of the class in the virtual machine. Once the object has be regenerated or reconstituted from the raw date, any call, method, or utility available within the runtime environment may be used to obtain information from, or manipulate, the object. Accordingly, at block 412, a call or a method may be executed on the object. In one embodiment, executing the call or the method on the object results in printing the object to string. Also, it should be understood that any and all steps or “blocks” and the detailed discussed therein with regard to the methods of FIG. 4 may be used or employed in the methods of FIGS. 2 and 3.

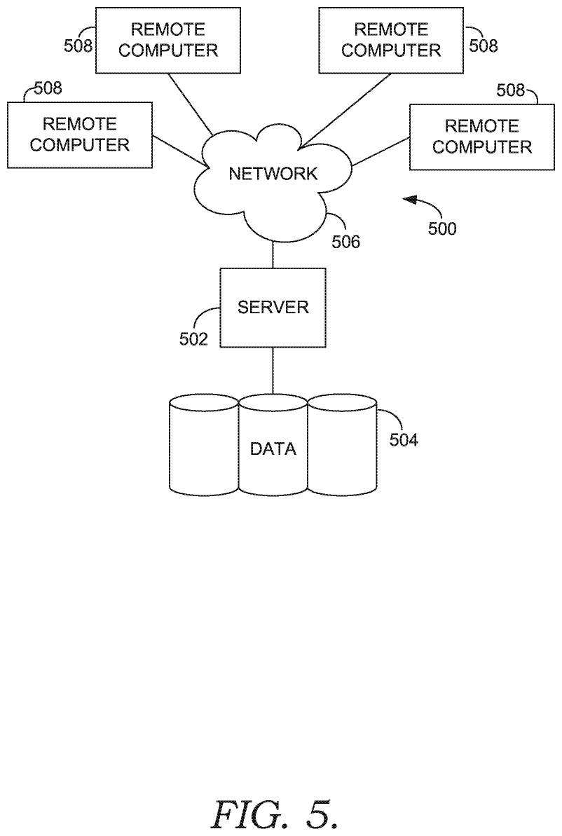

Hereinafter, an example of a computing environment is described with regard to the systems, methods, and computer-media described hereinabove. Turning to FIG. 5, the computing environment 500 is depicted, in accordance with an embodiment of the present invention. It will be understood by those of ordinary skill in the art that the computing environment 500 is just one example of a suitable computing environment and is not intended to limit the scope of use or functionality of the present invention. Similarly, the computing environment 500 should not be interpreted as imputing any dependency and/or any requirements with regard to each component and combination(s) of components illustrated in FIG. 5. It will be appreciated by those having ordinary skill in the art that the connections illustrated in FIG. 5 are also examples as other methods, hardware, software, and devices for establishing a communications link between the components, devices, systems, and entities, as shown in FIG. 5, may be utilized in implementation of the present invention. Although the connections are depicted using one or more solid lines, it will be understood by those having ordinary skill in the art that the example connections of FIG. 5 may be hardwired or wireless, and may use intermediary components that have been omitted or not included in FIG. 5 for simplicity's sake. As such, the absence of components from FIG. 5 should be not be interpreted as limiting the present invention to exclude additional components and combination(s) of components. Moreover, though devices and components are represented in FIG. 5 as singular devices and components, it will be appreciated that some embodiments may include a plurality of the devices and components such that FIG. 6 should not be considered as limiting the number of a device or component.

Continuing, the computing environment 500 of FIG. 5 is illustrated as being a distributed environment where components and devices may be remote from one another and may perform separate tasks. The components and devices may communicate with one another and may be linked to each other using a network 506. The network 506 may include wireless and/or physical (e.g., hardwired) connections. Examples of suitable networks include a telecommunications network of a service provider or carrier, Wide Area Network (WAN), a Local Area Network (LAN), a Wireless Local Area Network (WLAN), a cellular telecommunications network, a Wi-Fi network, a short range wireless network, a Wireless Metropolitan Area Network (WMAN), a Bluetooth® capable network, a fiber optic network, or a combination thereof. The network 506, generally, provides the components and devices access to the Internet and web-based applications.

The computing environment 500 includes a computing device 502 in the form of a server. Although illustrated as one component in FIG. 5, the present invention may utilize a plurality of local servers and/or remote servers in the computing environment 500. The computing device 502 may include components such as a processing unit, internal system memory, and a suitable system bus for coupling to various components, including a database or database cluster. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The computing device 502 may include or may have access to computer-readable media. Computer-readable media can be any available media that may be accessed by the computing device 502, and includes volatile and nonvolatile media, as well as removable and non-removable media. By way of example, and not limitation, computer-readable media may include computer storage media and communication media. Computer-readable storage media may include, without limitation, volatile and nonvolatile media, as well as removable and non-removable media, implemented in any method or technology for storage of information, such as computer-readable instructions, data structures, program modules, or other data. In this regard, computer storage media may include, but is not limited to, Random Access Memory (RAM), Read-Only Memory (ROM), Electrically Erasable Programmable Read-Only Memory (EEPROM), flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the computing device 502. Computer-readable storage media does not comprise signals per se.

Communication media may embody computer-readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above also may be included within the scope of computer-readable media.

In embodiments, the computing device 502 uses logical connections to communicate with one or more remote computers 508 within the computing environment 500. In embodiments where the network 506 includes a wireless network, the computing device 502 may employ a modem to establish communications with the Internet, the computing device 502 may connect to the Internet using Wi-Fi or wireless access points, or the server may use a wireless network adapter to access the Internet. The computing device 502 engages in two-way communication with any or all of the components and devices illustrated in FIG. 5, using the network 506. Accordingly, the computing device 502 may send data to and receive data from the remote computers 508 over the network 506.

Although illustrated as a single device, the remote computers 508 may include multiple computing devices. In an embodiment having a distributed network, the remote computers 508 may be located at one or more varied geographic locations. In an embodiment where the remote computers 508 is a plurality of computing devices, each of the plurality of computing devices may be located across various locations such as buildings in a campus, medical and research facilities at a medical complex, offices or “branches” of a banking/credit entity, or may be mobile devices that are wearable or carried by personnel, or attached to vehicles or trackable items in a warehouse, for example.

In some embodiments, the remote computers 508 is physically located in a medical setting such as, for example, a laboratory, inpatient room, an outpatient room, a hospital, a medical vehicle, a veterinary environment, an ambulatory setting, a medical billing office, a financial or administrative office, hospital administration setting, an in-home medical care environment, and/or medical professionals' offices. By way of example, a medical professional may include physicians; medical specialists such as surgeons, radiologists, cardiologists, and oncologists; emergency medical technicians; physicians' assistants; nurse practitioners; nurses; nurses' aides; pharmacists; dieticians; microbiologists; laboratory experts; genetic counselors; researchers; veterinarians; students; and the like. In other embodiments, the remote computers 508 may be physically located in a non-medical setting, such as a packing and shipping facility or deployed within a fleet of delivery or courier vehicles.

Continuing, the computing environment 500 includes a data store 504. Although shown as a single component, the data store 504 may be implemented using multiple data stores that are communicatively coupled to one another, independent of the geographic or physical location of a memory device. Data stores may, for example, store data in the form of artifacts, server lists, properties associated with servers, environments, properties associated with environments, computer instructions encoded in multiple different computer programming languages, deployment scripts, applications, properties associated with applications, release packages, version information for release packages, build levels associated with applications, identifiers for applications, identifiers for release packages, users, roles associated with users, permissions associated with roles, workflows and steps in the workflows, clients, servers associated with clients, attributes associated with properties, audit information, and/or audit trails for workflows. Examples of suitable data stores may also store data in the form of electronic records, for example, electronic medical records of patients, transaction records, billing records, task and workflow records, chronological event records, and the like.

Generally, the data store 504 includes physical memory that is configured to store information encoded in data. For example, the data store 504 may provide storage for computer-readable instructions, computer-executable instructions, data structures, data arrays, computer programs, applications, and other data that supports the functions and action to be undertaken using the computing environment 500 and components shown in the example of FIG. 5.

In a computing environment having distributed components that are communicatively coupled via the network 506, program modules may be located in local and/or remote computer storage media including, for example only, memory storage devices. Embodiments of the present invention may be described in the context of computer-executable instructions, such as program modules, being executed by a computing device. Program modules may include, but are not limited to, routines, programs, objects, components, and data structures that perform particular tasks or implement particular data types. In embodiments, the computing device 502 may access, retrieve, communicate, receive, and update information stored in the data store 504, including program modules. Accordingly, the computing device 502 may execute, using a processor, computer instructions stored in the data store 504 in order to perform embodiments described herein.

Although internal components of the devices in FIG. 5, such as the computing device 502, are not illustrated, those of ordinary skill in the art will appreciate that internal components and their interconnection are present in the devices of FIG. 5. Accordingly, additional details concerning the internal construction device are not further disclosed herein.

Also, the present invention has been described in relation to particular embodiments, which are intended in all respects to be illustrative rather than restrictive. Thus the present invention is not limited to these embodiments, but variations and modifications may be made without departing from the scope of the present invention.

What is claimed is:

1. One or more non-transitory computer-readable media having executable instructions embodied thereon that, when executed by a processor of a computing device, perform a method, the method comprising:
receiving raw data representing an object at a virtual machine, the raw data received from a heap dump;
transforming the raw data into an object in the virtual machine; and
executing a call or a method on the object.

2. The media of claim 1, wherein the heap dump is a Java-formatted heap dump.

3. The media of claim 1, wherein the virtual machine is a Java virtual machine.

4. The media of claim 1, wherein the object in the virtual machine is an instance of a class, wherein the object exhibits a behavior of the class in the virtual machine.

5. The media of claim 1, wherein the raw data represents content of the object.

6. The media of claim 5, wherein transforming the raw data into the object comprises generating, from the raw data that represents content of the object, a string that represents the content of the object.

7. The media of claim 6, wherein executing the call or the method on the object comprises printing the object to string.

8. The media of claim 1, further comprising:
receiving a query that specifies a particular object identifier to be retrieved from the heap dump, wherein the object identifier is an object name or a memory address; and
in response to the query, extracting the raw data that represents the object that corresponds to the particular object identifier from the heap dump.

9. The media of claim 1, further comprising:
executing a reflection application programming interface that calls at least one of a particular object class, a particular field, or a particular value to be retrieved from the heap dump; and
extracting the raw data that represents all objects that correspond to the at least one of the particular object class, the particular field, or the particular value from the heap dump.

10. One or more non-transitory computer-readable media having executable instructions embodied thereon that, when executed by a processor of a computing device, perform a method, the method comprising:
receiving an indication of an object identifier;
identifying raw data that represents an object corresponding to the object identifier in a heap dump;
loading the raw data that represents the object into a virtual machine; and
transforming the raw data into the object within the virtual machine.

11. The media of claim 10, wherein the object identifier is an object name, an object address, a class, or a field.

12. The media of claim 10, wherein the heap dump is a Java-formatted heap dump that stores the raw data, and wherein the virtual machine is a Java virtual machine.

13. The media of claim 10, wherein the raw data represents content of the object, wherein the object in the virtual machine is an instance of a class, and wherein the object exhibits a behavior of the class in the virtual machine.

14. The media of claim 13, wherein transforming the raw data into the object comprises generating, from the raw data that represent the content of the object, a string representation of the content of the object.

15. The media of claim 14, further comprising executing a call or a method on the object by printing the object to string.

16. The media of claim 15, wherein the string specifies a value for the object.

17. The media of claim 10, wherein loading the raw data into the virtual machine comprises placing the raw data into a running computer application.

18. The media of claim 17, wherein the running computer application transforms the raw data into the object, wherein the running computer application utilizes class information to automatically identify an internal structure of the object, and wherein when a call is made on the object to print a string representation, the string representation is output that provides the internal structure and value of the object.

19. A system comprising:
one or more processors configured to:
receive input that identifies an object;
locate raw data that represents the object identified from the input;
retrieve the raw data that represents the object from a heap dump;
load the raw data that represents the object into a virtual machine;
transform the raw data into the object within the virtual machine; and
execute a call or a method on the object.

20. The system of claim 19, wherein executing the call or the method on the object comprises printing the object to string.
